(19) United States
(12) Patent Application Publication
(10) Pub. No.: US 2011/0171459 A1
(43) Pub. Date: Jul. 14, 2011

(54) TWO-COMPONENT MOULDING PARTS WHICH ARE RESISTANT TO STRESS CRACKING AND WARPING, CONTAINING A PLATELET-LIKE OR FLAKED INORGANIC FILLER WITH THE EXCEPTION OF TALCUM

(75) Inventors: Andreas Seidel, Dormagen (DE); Eckhard Wenz, Koeln (DE); Manfred Nawroth, Wipperfuerth (DE); Rainer Protte, Dormagen (DE)

(73) Assignee: BAYER MATERIALSCIENCE AG, Leverkusen (DE)

(21) Appl. No.: 13/119,298

(22) PCT Filed: Sep. 17, 2009
(86) PCT No.: PCT/EP2009/006724

§ 371 Date: Mar. 28, 2011

(30) Foreign Application Priority Data
Sep. 20, 2008 (DE) 10 2008 048 202.1

(51) Int. Cl. B32B 27/18; B29C 70/00; B29C 45/16

(52) U.S. Cl. 428/323; 264/255

(57) ABSTRACT

The invention relates to ductile two-component moulding parts which are resistant to stress cracking and warping under the influence of chemicals, i.e. dimensionally stable two-component moulding parts.

The invention relates to ductile, low-distortion, that is to say dimensionally stable, two-component moulded parts which are resistant to stress cracking under the influence of chemicals, in which an amorphous thermoplastic moulding composition as a first component is completely or partially back-injected with a second, likewise amorphous moulding composition as a second component and stable material bonding of the second component to the first component is obtained.

The invention relates further to a process for the production of the two-component moulded parts by two-component injection moulding and to the use of the two-component moulded parts as, for example, a window or glazing module in the building industry and in motor vehicles, ships or aircraft, in lighting applications, as optical lenses with an integrally moulded surround, in automotive headlamp or tail-light applications, in non-transparent decorative components back-injected over the surface with transparent moulding compositions as a high-gloss layer in order to achieve a depth effect, as a (back-lightable) facing in motor vehicles, and as a transparent monitor/display cover with a contrasting (for example opaque or translucent and accordingly back-lightable) surround.

Two-component moulded parts in which a transparent or translucent amorphous material possesses a stable material bond to a second amorphous material are already known in principle from various fields of application. Polycarbonate, for example, is used as the transparent or translucent amorphous material of the first component. Polycarbonate or glass-fibre-filled compositions containing polycarbonate and styrene resin, for example, are used as the materials of the amorphous second component. For many fields of application, such two-component moulded parts known from the prior art exhibit inadequate ductility and/or inadequate resistance to stress cracking under the influence of chemicals and/or pronounced distortion, that is to say they have unsatisfactory dimensional stability.

The object of this invention was, therefore, to provide ductile, low-distortion, that is to say dimensionally stable, two-component moulded parts which are resistant to stress cracking under the influence of chemicals, consisting of an amorphous material as a first component and a second amorphous material as a second component.

Surprisingly, it has been found that the object according to the invention is achieved by two-component moulded parts containing

(i) as a first component an amorphous thermoplastic moulding composition containing
a) from 90 to 100 wt. %, preferably from 95 to 100 wt. %, particularly preferably from 98 to 100 wt. %, in particular from 99 to 99.99 wt. %, of amorphous thermoplastic material, preferably selected from at least one of the group consisting of aromatic polycarbonate, aromatic polyester carbonate, polystyrene (co)polymer and polymethyl methacrylate (co)polymer, and
b) from 0 to 10 wt. %, preferably from 0 to 5 wt. %, particularly preferably from 0 to 2 wt. %, in particular from 0.01 to 1 wt. %, of at least one commercially available polymer additive,

wherein the moulding composition of the first component is free of crystalline or semi-crystalline polymeric constituents, and

(ii) as a second component an amorphous thermoplastic moulding composition containing
A) from 10 to 100 parts by weight, preferably from 60 to 100 parts by weight, particularly preferably from 75 to 100 parts by weight, in particular also from 85 to 95 parts by weight (based on the sum of components A and B) of at least one component selected from the group consisting of aromatic polycarbonate, aromatic polyester carbonate, polymethyl methacrylate (co)polymer and polystyrene (co)polymer,
B) from 0 to 90 parts by weight, preferably from 0 to 40 parts by weight, particularly preferably from 0 to 25 parts by weight, in particular also from 5 to 15 parts by weight (based on the sum of components A and B) of at least one component selected from the group consisting of graft polymer prepared by the emulsion polymerisation process, graft polymer prepared by the mass polymerisation process, rubber-free vinyl homopolymer and rubber-free vinyl copolymer,
C) from 3 to 30 wt. %, preferably from 5 to 22 wt. %, particularly preferably from 6 to 15 wt. %, most particularly preferably from 7 to 12 wt. % (based on the total composition) of platelet-like or flaky inorganic filler, with the exception of talc, and
D) from 0 to 20 wt. %, preferably from 0.1 to 15 wt. %, particularly preferably from 0.1 to 5 wt. %, in particular from 0.2 to 4 wt. % (based on the total composition) of at least one commercially available polymer additive,

wherein the composition of the second component (ii) is free of crystalline or semi-crystalline polymeric constituents,

wherein the composition of the second component (ii) contains as component D isotropic inorganic filler in an amount of less than 3 wt. %, preferably from 0 to 2.5 wt. % (based on the total composition),

wherein the composition of the second component (ii) contains as component D talc in an amount of less than 3 wt. %, preferably from 0 to 2.5 wt. % (based on the total composition),

wherein the sum of the wt. % of components A and B in the total composition of the second component is calculated from the difference of 100 wt. % minus the sum of the parts by weight of components C and D,

wherein the first component (i) is completely or partially back-injected with the second component (ii), and

wherein the total composition of the second component is to be understood as being the sum of the wt. % of all the components A+B+C+D=100 wt. %.

By completely or partially back-injecting the first component (i) with the second component (ii), bonding of the second component (ii) to the first component (i) is achieved.

The invention further provides a process for the production of the two-component moulded parts by two-component injection moulding, wherein the first component (i) is completely or partially back-injected with the second component (ii).

In a preferred embodiment
the isotropically averaged moulding shrinkage (arithmetic mean of the moulding shrinkage values measured longitudinally and transversely to the melt flow direction) of the second component (ii) is reduced by from 10 to 40%, preferably from 12 to 35%, particularly preferably from 13 to 30%, in particular from 13 to 25%, as compared with the first component (i), and
the amount of the difference in the moulding shrinkage values of the second component (ii) measured longitudinally and transversely to the melt flow direction is not more than 30%, preferably not more than 20%, particularly preferably not more than 15%, in particular not more than 10%, of the arithmetic mean of the moulding shrinkage values of the second component (ii) measured longitudinally and transversely to the melt flow direction.

First Component (i)

Transparent or translucent amorphous moulding compositions are preferably used as the first component (i).

The preferred constituents a and b of the first component (i) are described hereinbelow.

Component a

Aromatic polycarbonates which are suitable according to the invention as component a are known in the literature or can be prepared by processes known in the literature (for the preparation of aromatic polycarbonates see, for example, Schnell, “Chemistry and Physics of Polycarbonates”, Interscience Publishers, 1964 as well as DE-AS 1 495 626, DE-A 2 232 877, DE-A 2 703 376, DE-A 2 714 544, DE-A 3 000 610, DE-A 3 832 396; for the preparation of aromatic polyester carbonates see e.g. DE-A 3 077 934).

The preparation of aromatic polycarbonates is carried out, for example, by reaction of diphenols with carbonic acid halides, preferably phosgene, and/or with aromatic dicarboxylic acid dihalides, preferably benzenedicarboxylic acid dihalides, by the interfacial process, optionally using chain terminators, for example monophenols, and optionally using branching agents having a functionality of three or more than three, for example triphenols or tetraphenols. Preparation by a melt polymerisation process by reaction of diphenols with, for example, diphenyl carbonate is likewise possible.

Diphenols for the preparation of the aromatic polycarbonates and/or aromatic polyester carbonates are preferably those of formula (I)

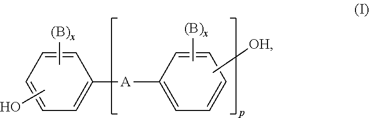

wherein

A represents a single bond, C₁- to C₅-alkylene, C₂- to C₅-alkylidene, C₅- to C₆-cycloalkylidene, —O—, —SO—, —CO—, —S—, —SO₂—, C₆- to C₁₂-arylene, to which there can be fused further aromatic rings optionally containing heteroatoms, or a radical of formula (II) or (III)

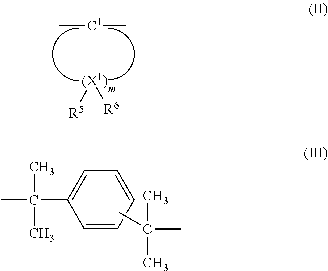

B in each case represents C₁- to C₁₂-alkyl, preferably methyl, halogen, preferably chlorine and/or bromine,

x in each case independently of one another represents 0, 1 or 2,

p represents 1 or 0, and

R⁵ and R⁶ can be chosen individually for each X¹ and, independently of one another, represent hydrogen or C₁- to C₆-alkyl, preferably hydrogen, methyl or ethyl,

X¹ represents carbon and

m represents an integer from 4 to 7, preferably 4 or 5, with the proviso that on at least one atom X¹, R⁵ and R⁶ are simultaneously alkyl.

Preferred diphenols are hydroquinone, resorcinol, dihydroxydiphenols, bis-(hydroxyphenyl)-C₁-C₅-alkanes, bis-(hydroxyphenyl)-C₅-C₆-cycloalkanes, bis-(hydroxyphenyl) ethers, bis-(hydroxyphenyl) sulfoxides, bis-(hydroxyphenyl) ketones, bis-(hydroxyphenyl)-sulfones and αα-bis-(hydroxyphenyl)-diisopropyl-benzenes as well as derivatives thereof brominated and/or chlorinated on the ring.

Particularly preferred diphenols are 4,4′-dihydroxydiphenyl, bisphenol A, 2,4-bis(4-hydroxyphenyl)-2-methylbutane, 1,1-bis-(4-hydroxyphenyl)-cyclohexane, 1,1-bis-(4-hydroxyphenyl)-3,3,5-trimethylcyclohexane, 4,4′-dihydroxydiphenyl sulfide, 4,4′-dihydroxydiphenylsulfone as well as di- and tetra-brominated or chlorinated derivatives thereof, such as, for example, 2,2-bis(3-chloro-4-hydroxyphenyl)-propane, 2,2-bis-(3,5-dichloro-4-hydroxyphenyl)-propane or 2,2-bis-(3,5-dibromo-4-hydroxyphenyl)-propane. Particular preference is given to 2,2-bis-(4-hydroxyphenyl)-propane (bisphenol A).

The diphenols can be used individually or in the form of arbitrary mixtures. The diphenols are known in the literature or are obtainable by processes known in the literature.

Chain terminators suitable for the preparation of the thermoplastic, aromatic polycarbonates are, for example, phenol, p-chlorophenol, p-tert-butylphenol or 2,4,6-tribromophenol, but also long-chained alkylphenols, such as 4-[2-(2,4,4-trimethylpentyl)]-phenol, 4-(1,3-tetramethylbutyl)-phenol according to DE-A 2 842 005 or monoalkylphenol or dialkylphenols having a total of from 8 to 20 carbon atoms in the alkyl substituents, such as 3,5-di-tert-butylphenol, p-isooctylphenol, p-tert-octylphenol, p-dodecylphenol and 2-(3,5-dimethylheptyl)-phenol and 4-(3,5-dimethylheptyl)-phenol. The amount of chain terminators to be used is generally from 0.5 mol % to 10 mol %, based on the molar sum of the diphenols used in each particular case.

The thermoplastic, aromatic polycarbonates have mean weight-average molecular weights (M_{w}, measured e.g. by GPC, ultracentrifugation or scattered light measurement) of from 10,000 to 200,000 g/mol, preferably from 15,000 to 80,000 g/mol, particularly preferably from 24,000 to 32,000 g/mol.

The thermoplastic, aromatic polycarbonates can be branched in known manner, preferably by the incorporation of from 0.05 to 2.0 mol %, based on the sum of the diphenols used, of compounds having a functionality of three or more than three, for example those having three or more phenolic groups.

Both homopolycarbonates and copolycarbonates are suitable. For the preparation of copolycarbonates of component a according to the invention, from 1 to 25 wt. %, preferably from 2.5 to 25 wt. %, based on the total amount of diphenols to be used, of polydiorganosiloxanes having hydroxyaryloxy end groups can also be used. These are known (U.S. Pat. No. 3,419,634) and can be prepared by processes known in the literature. The preparation of copolycarbonates containing polydiorganosiloxanes is described in DE-A 3 334 782.

Preferred polycarbonates, in addition to the bisphenol A homopolycarbonates, are the copolycarbonates of bisphenol A having up to 15 mol %, based on the molar sums of diphenols, of diphenols other than those mentioned as being preferred or particularly preferred, in particular 2,2-bis(3,5-dibromo-4-hydroxyphenyl)-propane.

Aromatic dicarboxylic acid dihalides for the preparation of aromatic polyester carbonates are preferably the diacid dichlorides of isophthalic acid, terephthalic acid, diphenyl ether 4,4′-dicarboxylic acid and naphthalene-2,6-dicarboxylic acid.

Particular preference is given to mixtures of the diacid dichlorides of isophthalic acid and terephthalic acid in a ratio of from 1:20 to 20:1.

In the preparation of polyester carbonates a carbonic acid halide, preferably phosgene, is additionally used concomitantly as bifunctional acid derivative.

There come into consideration as chain terminators for the preparation of the aromatic polyester carbonates, in addition to the monophenols already mentioned, also the chlorocarbonic acid esters thereof as well as the acid chlorides of aromatic monocarboxylic acids, which can optionally be substituted by C₁- to C₂₂-alkyl groups or by halogen atoms, as well as aliphatic C₂- to C₂₂-monocarboxylic acid chlorides.

The amount of chain terminators is in each case from 0.1 to 10 mol %, based in the case of phenolic chain terminators on moles of diphenol and in the case of monocarboxylic acid chloride chain terminators on moles of dicarboxylic acid dichloride.

The aromatic polyester carbonates can also contain aromatic hydroxycarboxylic acids incorporated therein.

The aromatic polyester carbonates can be both linear and branched in a known manner (see in this connection DE-A 2 940 024 and DE-A 3 007 934).

There can be used as branching agents, for example, carboxylic acid chlorides having a functionality of three or more, such as trimesic acid trichloride, cyanuric acid trichloride, 3,3′-4,4′-benzophenone-tetracarboxylic acid tetrachloride, 1,4,5,8-naphthalenetetracarboxylic acid tetrachloride or pyromellitic acid tetrachloride, in amounts of from 0.01 to 1.0 mol % (based on dicarboxylic acid dichlorides used), or phenols having a functionality of three or more, such as phloroglucinol, 4,6-dimethyl-2,4,6-tri-(4-hydroxyphenyl)-hept-2-ene, 4,6-dimethyl-2,4-6-tri-(4-hydroxyphenyl)-heptane, 1,3 ,5-tri-(4-hydroxyphenyl)-benzene, 1,1,1-tri-(4-hydroxyphenyl)-ethane, tri-(4-hydroxyphenyl)-phenylmethane, 2,2-bis[4,4-bis(4-hydroxy-phenyl)-cyclohexyl]-propane, 2,4-bis(4-hydroxyphenyl-isopropyl)-phenol, tetra-(4-hydroxyphenyl)-methane, 2,6-bis(2-hydroxy-5-methyl-benzyl)-4-methyl-phenol, 2-(4-hydroxyphenyl)-2-(2,4-dihydroxyphenyl)-propane, tetra-(4-[4-hydroxyphenyl-isopropyl]-phenoxy)-methane, 1,4-bis[4,4′-dihydroxytri-phenyl)-methyl]benzene, in amounts of from 0.01 to 1.0 mol %, based on diphenols used. Phenolic branching agents can be placed in a reaction vessel with the diphenols, acid chloride branching agents can be introduced together with the acid dichlorides.

The amount of carbonate structural units in the thermoplastic, aromatic polyester carbonates can vary as desired. Preferably, the amount of carbonate groups is up to 100 mol %, in particular up to 80 mol %, particularly preferably up to 50 mol %, based on the sum of ester groups and carbonate groups. Both the esters and the carbonates contained in the aromatic polyester carbonates can be present in the form of blocks or distributed randomly in the polycondensation product.

The relative solution viscosity (πᵣₑₗ) of the aromatic polycarbonates and polyester carbonates is in the range from 1.18 to 1.4, preferably from 1.20 to 1.32 (measured on solutions of 0.5 g of polycarbonate or polyester carbonate in 100 ml of methylene chloride solution at 25° C.).

The thermoplastic, aromatic polycarbonates and polyester carbonates can be used alone or in an arbitrary mixture.

Polymethyl methacrylate (co)polymers suitable according to the invention as component a are in a preferred embodiment (co)polymers of

a.1) from 50 to 100 wt. %, preferably from 70 to 100 wt. %, particularly preferably from 85 to 100 wt. %, in particular from 95 to 100 wt. %, based on component a, of methyl methacrylate with

a.2) from 0 to 50 wt. %, preferably from 0 to 30 wt. %, particularly preferably from 0 to 15 wt. %, in particular from 0 to 5 wt. %, based on component a, of at least one component selected from the group of alkyl or aryl methacrylates other than methyl methacrylate and/or alkyl or aryl acrylates having C₁- to C₁₀-alkyl, C₅-C₁₀-cycloalkyl or aryl ester radicals, acrylonitrile, methacrylonitrile, acrylamide, methacrylamide, 2-hydroxyethyl(meth)acrylic acid esters, maleic anhydride, maleic acid imides and optionally alkyl- and/or halo-substituted vinyl aromatic compounds, such as, for example, styrene, p-methylstyrene, α-methylstyrene.

These polymethyl methacrylate (co)polymers are resin-like, thermoplastic and rubber-free.

Pure polymethyl methacrylate is particularly preferred.

The preparation of the polymethyl methacrylate (co)polymers suitable according to the invention as component a is carried out in known manner by mass, solution or dispersion polymerisation of the monomer or monomers (Kunststoff-Handbuch, Volume IX, Polymethacrylate, Carl Hanser Verlag Munich 1975, pages 22-37).

Polystyrene (co)polymers suitable according to the invention as component a are in a preferred embodiment (co)polymers of

a.1) from 50 to 100 wt. %, preferably from 70 to 100 wt. %, particularly preferably from 85 to 100 wt. %, in particular from 95 to 100 wt. %, based on component a, of at least one monomer selected from the group of the vinyl aromatic compounds (such as, for example, styrene, α-methylstyrene) and vinyl aromatic compounds substituted on the ring (such as, for example, p-methylstyrene, p-chlorostyrene), in a preferred embodiment styrene, with

a.2) from 0 to 50 wt. %, preferably from 0 to 30 wt. %, particularly preferably from 0 to 15 wt. %, in particular from 0 to 5 wt. %, based on component a, of at least one monomer selected from the group of the vinyl cyanides (such as, for example, unsaturated nitriles such as acrylonitrile and methacrylonitrile), (meth)acrylic acid (C₁-C₈)-alkyl esters (such as, for example, methyl methacrylate, n-butyl acrylate, tert-butyl acrylate), unsaturated carboxylic acids and derivatives of unsaturated carboxylic acids (for example maleic anhydride and N-phenyl-maleimide).

These styrene (co)polymers are resin-like, thermoplastic and rubber-free.

Pure polystyrene is particularly preferred.

Such styrene (co)polymers are known and can be prepared by radical polymerisation, in particular by emulsion, suspension, solution or mass polymerisation. The styrene (co)polymers preferably have mean molecular weights M_{w} (weight-average, determined by GPC, light scattering or sedimentation) of from 15,000 to 250,000.

There is preferably used as component a an aromatic polycarbonate, in particular an aromatic polycarbonate based on bisphenol A.

Component b

The amorphous first component can contain further additives as component b. Suitable as further additives according to component b are in particular conventional polymer additives such as flameproofing agents (e.g. organic phosphorus or halogen compounds, in particular bisphenol-A-based oligophosphate, alkali/alkaline earth or ammonium/phosphonium salts of perfluorinated sulfonic acids), flameproofing synergists and antidripping agents (for example compounds of the substance classes of the fluorinated polyolefins, of the silicones as well as aramid fibres), smoke-inhibiting additives (for example boric acid or borates), internal and external lubricating and demoulding agents, for example pentaerythritol tetrastearate or glycidyl monostearate, flowability aids, antistatics, conductivity additives, stabilisers, for example antioxidants, UV stabilisers, transesterification inhibitors, hydrolytic stabilisers, processing stabilisers, IR absorbents, optical brightening agents, fluorescent additives, additives having antibacterial action, additives improving scratch resistance, impact modifiers such as, for example, graft polymers preferably prepared by emulsion polymerisation, in a preferred embodiment those having a core/shell structure, filling and reinforcing materials, preferably in very finely divided, in particular nanoscale, form, as well as colourings and pigments.

Second component (ii)

Amorphous moulding compositions are used as the second component (ii). They are preferably opaque, that is to say non-transparent, materials.

The preferred constituents A, B, C and D of the second component (ii) are described hereinbelow.

Component A

Component A of the second component (ii) corresponds in its embodiments to component a of the first component (i).

Component B

Component B is selected from at least one representative of the group of the graft polymers B.1 or of the rubber-free (co)polymers B.2.

Component B.1 comprises one or more graft polymers of

B.1.1 from 5 to 95 wt. %, preferably from 30 to 90 wt. %, of at least one vinyl monomer on

B.1.2 from 95 to 5 wt. %, preferably from 70 to 10 wt. %, of one or more graft bases having glass transition temperatures<10° C., preferably<0° C., particularly preferably<−20° C.

The graft base B.1.2 generally has a mean particle size (d₅₀ value) of from 0.05 to 10 μm, preferably from 0.1 to 5 μm, particularly preferably from 0.15 to 2.0 μm.

Monomers B.1.1 are preferably mixtures of

B.1.1.1 from 50 to 99 parts by weight of vinyl aromatic compounds and/or vinyl aromatic compounds substituted on the ring (such as styrene, α-methylstyrene, p-methylstyrene, p-chlorostyrene) and/or methacrylic acid (C₁-C₈)-alkyl esters, such as methyl methacrylate, ethyl methacrylate, and

B.1.1.2 from 1 to 50 parts by weight of vinyl cyanides (unsaturated nitriles such as acrylonitrile and methacrylonitrile) and/or (meth)acrylic acid (C₁-C₈)-alkyl esters, such as methyl methacrylate, n-butyl acrylate, tert-butyl acrylate, and/or derivatives (such as anhydrides and imides) of unsaturated carboxylic acids, for example maleic anhydride and N-phenyl-maleimide.

Preferred monomers B.1.1.1 are selected from at least one of the monomers styrene, α-methylstyrene and methyl methacrylate; preferred monomers B.1.1.2 are selected from at least one of the monomers acrylonitrile, maleic anhydride and methyl methacrylate. Particularly preferred monomers are B.1.1.1 styrene and B.1.1.2 acrylonitrile.

Graft bases B.1.2 suitable for the graft polymers B.1 are, for example, diene rubbers, EP(D)M rubbers, that is to say those based on ethylene/propylene and optionally diene, acrylate, polyurethane, silicone, chloroprene and ethylene/vinyl acetate rubbers as well as silicone/acrylate composite rubbers.

Preferred graft bases B.1.2 are diene rubbers, for example based on butadiene and isoprene, or mixtures of diene rubbers or copolymers of diene rubbers or mixtures thereof with further copolymerisable monomers (e.g. according to B.1.1.1 and B.1.1.2), with the proviso that the glass transition temperature of component B.2 is below<10° C., preferably<0° C., particularly preferably<−20° C. Pure polybutadiene rubber is particularly preferred.

Particularly preferred polymers B.1 are, for example, ABS polymers (emulsion, mass and suspension ABS), as are described, for example, in DE-OS 2 035 390 (=U.S. Pat. No. 3,644,574) or in DE-OS 2 248 242 (=GB-PS 1 409 275) or in Ullmanns, Enzyklopädie der Technischen Chemie, Vol. 19 (1980), p. 280 ff.

The graft copolymers B.1 are prepared by radical polymerisation, for example by emulsion, suspension, solution or mass polymerisation, preferably by emulsion or mass polymerisation, particularly preferably by emulsion polymerisation.

The gel content of the graft base B.1.2 in the case of graft polymers prepared by emulsion polymerisation is at least 30 wt. %, preferably at least 40 wt. % (measured in toluene).

The gel content of graft polymers B.1 prepared by mass polymerisation is preferably from 10 to 50 wt. %, in particular from 15 to 40 wt. % (measured in acetone).

Particularly suitable graft rubbers are also ABS polymers prepared by redox initiation with an initiator system of organic hydroperoxide and ascorbic acid according to U.S. Pat. No. 4,937,285.

Because it is known that the graft monomers are not necessarily grafted completely on to the graft base in the graft reaction, graft polymers B.1 are also understood according to the invention as being products that are obtained by (co)polymerisation of the graft monomers in the presence of the graft base and that are obtained concomitantly on working up. These products can accordingly also contain free (co)polymer of the graft monomers, that is to say (co)polymer that is not chemically bonded to the rubber.

In the case of graft polymers B.1 prepared by the mass polymerisation process, the weight-average molecular weight M_{w} of the free (co)polymer, that is to say of the (co)polymer that is not bonded to the rubber, is preferably from 50,000 to 250,000 g/mol, in particular from 60,000 to 180,000 g/mol, particularly preferably from 70,000 to 130,000 g/mol.

Suitable acrylate rubbers according to B.1.2 are preferably polymers of acrylic acid alkyl esters, optionally with up to 40 wt. %, based on B.1.2, of other polymerisable, ethylenically unsaturated monomers. The preferred polymerisable acrylic acid esters include C₁- to C₈-alkyl esters, for example methyl, ethyl, butyl, n-octyl and 2-ethylhexyl esters; haloalkyl esters, preferably halo-C₁-C₈-alkyl esters, such as chloroethyl acrylate, as well as mixtures of these monomers.

For crosslinking, monomers having more than one polymerisable double bond can be copolymerised. Preferred examples of crosslinking monomers are esters of unsaturated monocarboxylic acids having from 3 to 8 carbon atoms and unsaturated monohydric alcohols having from 3 to 12 carbon atoms, or saturated polyols having from 2 to 4 OH groups and from 2 to 20 carbon atoms, such as ethylene glycol dimethacrylate, allyl methacrylate; polyunsaturated heterocyclic compounds, such as trivinyl and triallyl cyanurate; polyfunctional vinyl compounds, such as di- and tri-vinylbenzenes; but also triallyl phosphate and diallyl phthalate. Preferred crosslinking monomers are allyl methacrylate, ethylene glycol dimethacrylate, diallyl phthalate and heterocyclic compounds containing at least three ethylenically unsaturated groups. Particularly preferred crosslinking monomers are the cyclic monomers triallyl cyanurate, triallyl isocyanurate, triacryloylhexahydro-s-triazine, triallylbenzenes. The amount of crosslinked monomers is preferably from 0.02 to 5 wt. %, in particular from 0.05 to 2 wt. %, based on the graft base B.1.2. In the case of cyclic crosslinking monomers having at least three ethylenically unsaturated groups it is advantageous to limit the amount to less than 1 wt. % of the graft base B.1.2.

Preferred “other” polymerisable, ethylenically unsaturated monomers which can optionally be used in addition to the acrylic acid esters in the preparation of the graft base B.1.2 are, for example, acrylonitrile, styrene, α-methylstyrene, acrylamides, vinyl C₁-C₆-alkyl ethers, methyl methacrylate, butadiene.

W LET 194822 vl 2901664-060000

Preferred acrylate rubbers as graft base B.2 are emulsion polymers having a gel content of at least 60 wt. %.

Further suitable graft bases according to B.1.2 are silicone rubbers having graft-active sites, as are described in DE-OS 3 704 657, DE-OS 3 704 655, DE-OS 3 631 540 and DE-OS 3 631 539.

The gel content of the graft base B.1.2 or of the graft polymers B.1 is determined at 25° C. in a suitable solvent as the fraction insoluble in such solvents (M. Hoffmann, H. Krömer, R. Kuhn, Polymeranalytik I und II, Georg Thieme-Verlag, Stuttgart 1977).

The mean particle size d₅₀ is the diameter above and below which in each case 50 wt. % of the particles lie. It can be determined by means of ultracentrifuge measurement (W. Scholtan, H. Lange, Kolloid, Z. und Z. Polymere 250 (1972), 782-1796).

The rubber-free vinyl (co)polymers B.2 are rubber-free homo- and/or co-polymers of at least one monomer from the group of the vinyl aromatic compounds, vinyl cyanides (unsaturated nitriles), (meth)acrylic acid (C₁ to C₈)-alkyl esters, unsaturated carboxylic acids and derivatives (such as anhydrides and imides) of unsaturated carboxylic acids.

Particularly suitable are (co)polymers B.2 of

B.2.1 from 50 to 99 wt. %, based on the (co)polymer B.2, of at least one monomer selected from the group of the vinyl aromatic compounds (such as, for example, styrene, α-methylstyrene), vinyl aromatic compounds substituted on the ring (such as, for example, p-methylstyrene, p-chlorostyrene) and (meth)acrylic acid (C₁-C₈)-alkyl esters (such as, for example, methyl methacrylate, n-butyl acrylate, tert-butyl acrylate) and

B.2.2 from 1 to 50 wt. %, based on the (co)polymer B.2, of at least one monomer selected from the group of the vinyl cyanides (such as, for example, unsaturated nitriles such as acrylonitrile and methacrylonitrile), (meth)acrylic acid (C₁-C₈)-alkyl esters (such as, for example, methyl methacrylate, n-butyl acrylate, tert-butyl acrylate), unsaturated carboxylic acids and derivatives of unsaturated carboxylic acids (for example maleic anhydride and N-phenyl-maleimide).

These (co)polymers B.2 are resin-like, thermoplastic and rubber-free. The copolymer of styrene and acrylonitrile is particularly preferred.

Such (co)polymers B.2 are known and can be prepared by radical polymerisation, in particular by emulsion, suspension, solution or mass polymerisation. The (co)polymers preferably have mean molecular weights M_{w} (weight-average, determined by GPC, light scattering or sedimentation) of from 15,000 to 250,000.

There can be used as component B a pure graft polymer B.1 or a mixture of a plurality of graft polymers according to B.1, a pure (co)polymer B.2 or a mixture of a plurality of (co)polymers according to B.2, or a mixture of at least one graft polymer B.1 with at least one (co)polymer B.2. If mixtures of a plurality of graft polymers, mixtures of a plurality of (co)polymers or mixtures of at least one graft polymer with at least one (co)polymer are used, then these can be used separately in the preparation of the compositions according to the invention or alternatively in the form of a precompound.

In a preferred embodiment, a pure graft polymer B.1 or a mixture of a plurality of graft polymers according to B.1 or a mixture of at least one graft polymer B.1 with at least one (co)polymer B.2 is used as component B.

In a particularly preferred embodiment, an ABS graft polymer prepared by emulsion polymerisation or an

ABS graft polymer prepared by mass polymerisation or a mixture of a graft polymer prepared by emulsion polymerisation and an SAN copolymer is used as component B.

Component C

A naturally occurring or synthetically produced inorganic platelet-like or flaky filler other than talc is used as component C.

A platelet-like or flaky filler is understood within the scope of the invention as being such a filler whose particle extent in two preferential directions that are orthogonal relative to one another is markedly larger than the particle extent in the third dimension orthogonal to the two first-mentioned preferential directions. Such platelet-like particles generally have a ratio of the mean diameter to the mean thickness of the platelets, determined by methods known to the person skilled in the art, such as, for example, by evaluation by means of an electron microscope, of from 2 to 60, preferably from 3 to 50, particularly preferably from 4 to 40, in particular from 5 to 30.

Micas, montmorillonites, layered clay minerals, phyllosilicates, kaolin and graphite, for example, are suitable according to the invention as component C.

Micas, montmorillonites, layered clay minerals, phyllosilicates or kaolins that are preferably used are those having a low iron content of not more than 1 wt. %, preferably not more than 0.5 wt. %, particularly preferably not more than 0.2 wt. %, in particular not more than 0.1 wt. %.

The use of the filler in the form of finely ground types having a mean particle diameter d₅₀ of<10 μm, preferably<5 μm, particularly preferably<2 μm, most particularly preferably from 0.005 μm to 1.5 μm, is particularly advantageous.

The filler can be surface-treated, for example silanised, in order to ensure better compatibility with the polymer.

In view of the processing and production of the moulding compositions, the use of compacted fillers having a high bulk density is advantageous.

Component D

The composition can contain further additives as component D. Suitable as further additives according to component D are preferably commercially available polymer additives selected from the group consisting of flameproofing agents (for example phosphorus or halogen compounds), flameproofing synergists (for example nano-scale metal oxides), smoke-inhibiting additives (for example boric acid or borates), antidripping agents (for example compounds of the substance classes of the fluorinated polyolefins, of the silicones as well as aramid fibres), internal and external lubricating and demoulding agents (for example pentaerythritol tetrastearate, Montan wax or polyethylene wax), flowability aids (for example low molecular weight vinyl (co)polymers), antistatics (for example block copolymers of ethylene oxide and propylene oxide, other polyethers or polyhydroxy ethers, polyether amides, polyester amides or sulfonic acid salts), conductivity additives (for example conductive black or carbon nanotubes), stabilisers (for example UV/light stabilisers, heat stabilisers, antioxidants, transesterification inhibitors, hydrolytic stabilisers), additives having antibacterial action (for example silver or silver salts), additives improving scratch resistance (for example silicone oils), IR absorbents, optical brightening agents, fluorescent additives , impact modifiers (for example graft polymers with a rubber core, preferably prepared by emulsion polymerisation, which in a particularly preferred embodiment have a core/shell structure), Brönsted acids, filling and reinforcing materials other than component C (for example wollastonites, (ground) glass or carbon fibres, chalk, kaolin, talc, quartz, and glass or ceramics beads) as well as colourings and pigments.

If talc or an isotropic inorganic filler is used as component D, it is used in a concentration of less than in each case 3 wt. %, preferably from 0 to 2.5 wt. %, based on the total composition.

An isotropic filler within the scope of the invention is understood as being a filler having largely isotropic (e.g. spherical or cubic, i.e. cube-like) particle geometry. The extent of such particles in various dimensions differ from one another only slightly, if at all. The quotient of the largest and smallest particle extent in the case of such “isotropic fillers” is not more than 5, preferably not more than 3, particularly preferably not more than 2, in particular not more than 1.5. They are, for example, (hollow) glass beads, (hollow) ceramics beads, ground glass fibres, kaolin, carbon black, magnesium hydroxide, aluminium hydroxide, aluminium oxide, boehmite, hydrotalcite, amorphous graphite, quartz, Aerosil, further metal or transition metal oxides (for example titanium dioxide or iron oxide), sulfates (for example barium or calcium sulfate), borates (for example zinc borate), carbonates (for example chalk or other forms of calcium carbonate or magnesium carbonate), silicates or alumosilicates (for example ground wollastonite) and nitrides (for example boron nitride).

In a preferred embodiment the composition of the second component (ii) is free of talc and free of isotropic inorganic fillers.

As flameproofing agents according to component D there are preferably used phosphorus-containing compounds. These are preferably selected from the groups of the monomeric and oligomeric phosphoric and phosphonic acid esters, phosphonate amines and phosphazenes, it also being possible for mixtures of a plurality of components selected from one or various of those groups to be used as flameproofing agents. Halogen-free phosphorus compounds not mentioned specifically here can also be used on their own or in an arbitrary combination with other halogen-free phosphorus compounds.

Preferred monomeric and oligomeric phosphoric or phosphonic acid esters are phosphorus compounds of the general formula (IV)

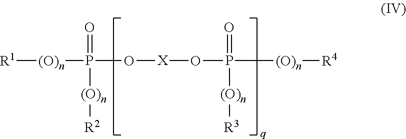

wherein

R¹, R², R³ and R⁴, independently of one another, represent in each case optionally halogenated C₁- to C₈-alkyl, C₅- to C₆-cycloalkyl, C₆- to C₂₀-aryl or C₇- to C₁₂-aralkyl in each case optionally substituted by alkyl, preferably C₁- to C₄-alkyl, and/or by halogen, preferably chlorine, bromine, the substituents n independently of one another represent 0 or 1,

q represents from 0 to 30 and

X represents a mono- or poly-nuclear aromatic radical having from 6 to 30 carbon atoms, or a linear or branched aliphatic radical having from 2 to 30 carbon atoms which can be OH-substituted and can contain up to 8 ether bonds.

Preferably, R¹, R², R³ and R⁴, independently of one another, represent C₁- to C₄-alkyl, phenyl, naphthyl or phenyl-C₁-C₄-alkyl. The aromatic groups R¹, R², R³ and R⁴ can in turn be substituted by halogen and/or alkyl groups, preferably chlorine, bromine and/or C₁- to C₄-alkyl. Particularly preferred aryl radicals are cresyl, phenyl, xylenyl, propylphenyl or butylphenyl as well as the corresponding brominated and chlorinated derivatives thereof.

X in formula (IV) preferably represents a mono- or poly-nuclear aromatic radical having from 6 to 30 carbon atoms. The radical is preferably derived from diphenols of formula (I).

The substituents n in formula (IV), independently of one another, can be 0 or 1; preferably, n is equal to 1.

q represents values of from 0 to 30, preferably from 0.3 to 20, particularly preferably from 0.5 to 10, in particular from 0.5 to 6, most particularly preferably from 1.1 to 1.6.

X particularly preferably represents

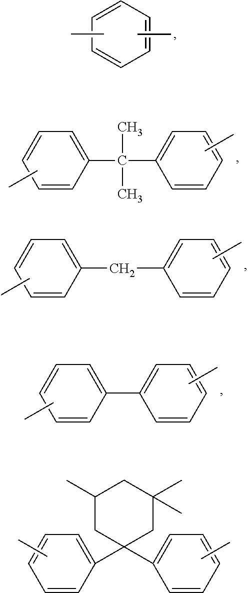

or chlorinated or brominated derivatives thereof; in particular, X is derived from resorcinol, hydroquinone, bisphenol A or diphenylphenol. Particularly preferably, X is derived from bisphenol A.

Mixtures of different phosphates can also be used as component D according to the invention.

Phosphorus compounds of formula (IV) are in particular tributyl phosphate, triphenyl phosphate, tricresyl phosphate, diphenylcresyl phosphate, diphenyloctyl phosphate, diphenyl-2-ethylcresyl phosphate, tri-(isopropylphenyl) phosphate, resorcinol-bridged oligophosphate and bisphenol-A-bridged oligophosphate. The use of oligomeric phosphoric acid esters of formula (IV) which are derived from bisphenol A is particularly preferred.

Most preferred as component D is the bisphenol-A-based oligophosphate according to formula (IVa)

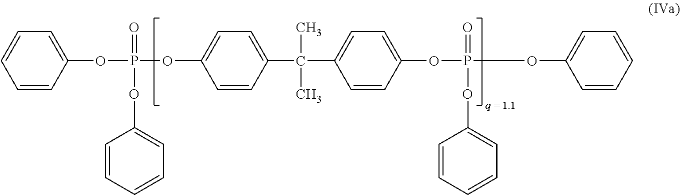

The phosphorus compounds according to component D are known (see e.g. EP-A 0 363 608, EP-A 0 640 655) or can be prepared by known methods in an analogous manner (e g Ullmanns Enzyklopädie der technischen Chemie, Vol. 18, p. 301 ff 1979; Houben-Weyl, Methoden der organischen Chemie, Vol. 12/1, p. 43; Beilstein Vol. 6, p. 177).

When mixtures of different phosphorus compounds are used, and in the case of oligomeric phosphorus compounds, the indicated q value is the mean q value. The mean q value can be determined by determining the composition of the phosphorus compound (molecular weight distribution) by means of a suitable method (gas chromatography (GC), high-pressure liquid chromatography (HPLC), gel permeation chromatography (GPC)) and calculating the mean values for q therefrom.

Further, phosphonate amines and phosphazenes, as are described in WO 00/00541 and WO 01/18105, can be used as flameproofing agents.

The flameproofing agents can be used on their own or in arbitrary mixtures with one another or in admixture with other flameproofing agents.

In a preferred embodiment the flameproofing agents are used in combination with polytetrafluoroethylene (PTFE) as antidripping agent.

The composition of the first component (i) and of the second component (ii) is in each case free of crystalline or semi-crystalline polymeric constituents, and the compositions according to the invention of components (i) and (ii) are in particular free of aromatic or partially aromatic polyesters, as are disclosed in WO-A 99/28386. Aromatic or partially aromatic polyesters are understood within the scope of the invention as being not the amorphous polycarbonates that can be used as component a or component A.

The aromatic polyesters are derived from aromatic dihydroxy compounds and aromatic dicarboxylic acids or aromatic hydroxycarboxylic acids. The partially aromatic polyesters are those based on aromatic dicarboxylic acids and one or more different aliphatic dihydroxy compounds.

Brönsted acids suitable as component D are in principle all types of Bronsted-acidic organic or inorganic compounds or mixtures thereof.

Preferred organic acids according to component D are selected from at least one of the group of the aliphatic or aromatic, optionally multifunctional carboxylic acids, sulfonic acids and phosphonic acids. Aliphatic or aromatic dicarboxylic acids and hydroxy-functionalised dicarboxylic acids are particularly preferred.

In a preferred embodiment at least one compound selected from the group consisting of benzoic acid, citric acid, oxalic acid, fumaric acid, mandelic acid, tartaric acid, terephthalic acid, isophthalic acid, p-toluenesulfonic acid is used as component D.

Preferred inorganic acids are ortho- and meta-phosphoric acids and acidic salts of those acids, as well as boric acid.

Preparation of the Moulding Compositions of the First and Second Component

The thermoplastic moulding compositions used as the first and second component can be prepared, for example, by mixing the constituents in a known manner and melt compounding and melt extruding the mixture at temperatures of from 200° C. to 360° C., preferably at from 240 to 340° C., particularly preferably at from 240 to 320° C., in conventional devices such as internal kneaders, extruders and twin-shaft screws.

Mixing of the individual constituents can be carried out in known manner either in succession or simultaneously, either at about 20° C. (room temperature) or at a higher temperature.

Two-Component Moulded Parts According to the Invention

The production of the low-distortion, that is to say dimensionally stable, ductile two-component structural elements that are resistant to stress cracking under the influence of chemicals is carried out by two-component injection moulding. The transparent or translucent first component is thereby completely or partially back-injected with the second component after a certain cooling time, resulting in stable material bonding of the second component to the first component.

These two-component structural elements can be, for example, a flat composite of a transparent or translucent layer with an opaque impact-modified layer, or a composite of a transparent or translucent surface framed by an opaque surround. Such composites can be used, for example, in the window and glazing sector, in lighting applications, in optical lenses with an integrally moulded opaque surround, in headlamp cover plates with an opaque surround, in non-transparent decorative covers back-injected over the surface with a transparent thermoplastic as a high-gloss layer in order to achieve a depth effect, in (back-lit) facings in motor vehicles, and in monitor/display covers with an opaque surround.

The above-mentioned two-component structural elements are preferably produced in a process in which the first component is back-injected with the second component by the injection moulding or injection compression moulding process (two-component injection moulding process or two-component injection compression moulding process).

The invention therefore also provides a process for the production of the two-component structural elements according to the invention.

1. Two-component moulded part comprising
(i) as a first component an amorphous thermoplastic moulding composition comprising
a) from 90 to 100 wt. % (based on the sum of components a and b) of amorphous thermoplastic material, and
b) from 0 to 10 wt. % (based on the sum of components a and b) of at least one polymer additive,
wherein the moulding composition of the first component is free of crystalline or semi-crystalline polymeric constituents, and
(ii) as a second component an amorphous thermoplastic moulding composition comprising
A) from 10 to 100 parts by weight (based on the sum of components A and B) of at least one component selected from the group consisting of aromatic polycarbonate, aromatic polyester carbonate, polymethyl methacrylate (co)polymer and polystyrene (co)polymer,
B) from 0 to 90 parts by weight (based on the sum of components A and B) of at least one component selected from the group consisting of graft polymer prepared by the emulsion polymerisation process, graft polymer prepared by the mass polymerisation process, rubber-free vinyl homopolymer and rubber-free vinyl copolymer,
C) from 3 to 30 wt. % (based on the total composition) of platelet-like or flaky inorganic filler, with the exception of talc, and
D) from 0 to 20 wt. % (based on the total composition) of at least one polymer additive,
wherein the composition of the second component (ii) is free of crystalline or semi-crystalline polymeric constituents,
wherein the composition of the second component (ii) comprises as component D isotropic inorganic filler in an amount of less than 3 wt. % (based on the total composition),
wherein the composition of the second component (ii) comprises as component D talc in an amount of less than 3 wt. % (based on the total composition),
wherein the sum of the wt. % of components A and B in the total composition of the second component is calculated from the difference of 100 wt. % minus the sum of the parts by weight of components C and D, and
wherein the first component (i) is completely or partially back-injected with the second component (ii).

2. Two-component moulded part according to claim 1, wherein component a) of the first component (i) is selected from at least one of the group consisting of aromatic polycarbonate, aromatic polyester carbonate, polystyrene (co)polymer and polymethyl methacrylate (co)polymer.

3. Two-component moulded part according to claim 2, wherein component b) of the first component (i) is selected from at least one of the group consisting of flameproofing agents, flameproofing synergists and antidripping agents, smoke-inhibiting additives, internal and external lubricating and demoulding agents, flowability aids, antistatics, conductivity additives, stabilisers, IR absorbents, optical brightening agents, fluorescent additives, additives having antibacterial action, additives improving scratch resistance, impact modifiers, colourings and pigments.

4. Two-component moulded part according to claim 2 comprising from 99 to 99.99 wt. % of component a) and from 0.01 to 1 wt. % of component b).

5. Two-component moulded part according to claim 2 comprising
A) from 60 to 100 parts by weight (based on the sum of components A and B) of component A),
B) from 0 to 40 parts by weight (based on the sum of components A and B) of component B),
C) from 5 to 22 wt. % (based on the total composition) of component C),
D) from 0.1 to 15 wt. % (based on the total composition) of component D).

6. Two-component moulded parts according to claim 5, wherein component D is selected from at least one of the group consisting of flameproofing agents, flameproofing synergists, smoke-inhibiting additives, antidripping agents, internal and external lubricating and demoulding agents, flowability aids, antistatics, conductivity additives, UV/light stabilisers, heat stabilisers, antioxidants, transesterification inhibitors, hydrolytic stabilisers, additives having antibacterial action, additives improving scratch resistance, IR absorbents, optical brightening agents, fluorescent additives, impact modifiers, Brönsted acids, filling and reinforcing materials other than component C, as well as colourings and pigments.

7. Two-component moulded part according to claim 5, wherein component D is selected from at least one of the group consisting of flameproofing agents, flameproofing synergists, smoke-inhibiting additives, antidripping agents, internal and external lubricating and demoulding agents, flowability aids, antistatics, conductivity additives, UV/light stabilisers, heat stabilisers, antioxidants, transesterification inhibitors, hydrolytic stabilisers, additives having antibacterial action, additives improving scratch resistance, IR absorbents, optical brightening agents, fluorescent additives, impact modifiers, Brönsted acids, as well as colourings and pigments.

8. Two-component moulded part according to claim 5 comprising as component D) a phosphorus compound of formula (IV) 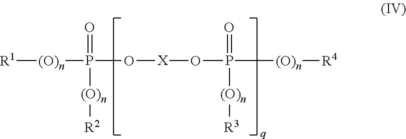
wherein
R¹, R², R³ and R⁴, independently of one another, represent in each case optionally halogenated C₁- to C₈-alkyl, substituted C₅- to C₆-cycloalkyl, C₆- to C₂₀-aryl or C₇- to C₁₂-aralkyl,
the substituents n independently of one another represent 0 or 1,
q represents from 0 to 30 and
X represents a mono- or poly-nuclear aromatic radical having from 6 to 30 carbon atoms, or a linear or branched aliphatic radical having from 2 to 30 carbon atoms which can be OH-substituted and can contain up to 8 ether bonds.

9. Two-component moulded part according to claim 1, wherein a transparent or translucent amorphous moulding composition is used as the first component (i).

10. Two-component moulded part according to claim 9, wherein an opaque moulding composition is used as the second component (ii).

11. Two-component moulded part according to claim 1, wherein
the isotropically averaged moulding shrinkage (arithmetic mean of the moulding shrinkage values measured longitudinally and transversely to the melt flow direction) of the second component (ii) is reduced by from 10 to 40% as compared with the first component (i), and
the amount of the difference in the moulding shrinkage values of the second component (ii) measured longitudinally and transversely to the melt flow direction is not more than 30% of the arithmetic mean of the moulding shrinkage values of the second component (ii) measured longitudinally and transversely to the melt flow direction.

12. Process for the production of the two-component moulded part according to claim 1 by two-component injection moulding, wherein the first component (i) is completely or partially back-injected with the second component (ii).

13. Use of the A two-component moulded part according to claim 1 as a window or glazing module in the building industry and in motor vehicles, ships or aircraft, in lighting applications, as optical lenses with an integrally moulded surround, in automotive headlamp or tail-light applications, in non-transparent decorative components back-injected over the surface with transparent moulding compositions as a high-gloss layer in order to achieve a depth effect, as a facing in motor vehicles, and as a transparent monitor/display cover with an opaque surround.
